(19) United States
(12) Patent Application Publication
(10) Pub. No.: US 2015/0103556 A1
(43) Pub. Date: Apr. 16, 2015

(54) PACKAGE CARRIER

(71) Applicant: Genesis Photonics Inc., Tainan City (TW)

(72) Inventors: Shao-Ying Ting, Tainan City (TW); Jing-En Huang, Tainan City (TW); Pei-Hsin Chen, Tainan City (TW); Chih-Ling Wu, New Taipei City (TW); Yi-Ru Huang, Tainan City (TW); Yu-Yun Lo, Tainan City (TW)

(21) Appl. No.: 14/513,210

(22) Filed: Oct. 14, 2014

(30) Foreign Application Priority Data
Oct. 14, 2013 (TW) 102136993

(51) Int. Cl. F21V 8/00

(52) U.S. Cl. CPC G02B 6/0031; G02B 6/009; G02B 6/0085; G02B 6/0073; F21Y 2101/02
USPC 362/609; 362/611; 362/612

(57) ABSTRACT

A package carrier is suitable for carrying at least one light emitting unit. The package carrier includes an annular shell and a transparent light guiding stage. The annular shell has a cavity. The transparent light guiding stage is disposed in the cavity of the annular shell. The light emitting unit is adapted to be disposed on the transparent light guiding stage, and a horizontal projection area of the transparent light guiding stage is greater than that of the light emitting unit. The light emitting unit emits a light beam to enter the transparent light guiding stage, and the light beam emits from a surface of the transparent light guiding stage relatively distant from the cavity.

### CROSS-REFERENCE TO RELATED APPLICATION

This application claims the priority benefit of Taiwan application serial no. 102136993, filed on Oct. 14, 2013. The entirety of the above-mentioned patent application is hereby incorporated by reference herein and made a part of this specification.

### BACKGROUND OF THE INVENTION

1. Field of the Invention

The invention generally relates to a package carrier, and more particularly, to a package carrier for carrying the light-emitting diode (LED).

2. Description of Related Art

With the advances in optoelectronic technology, the light-emitting diode (LED) technology used to replace the traditional incandescent bulbs and fluorescent lamps and serving as the new generation light source gradually gets mature. The LED has advantage of low power consumption, small size, non-thermal luminescence and environmental protection, so that its application areas are gradually extended.

In the conventional package structure of LED, the LED is disposed in the package carrier and covered by fluorescent encapsulant. Otherwise, the package encapsulant covers the fluorescent encapsulant and the package carrier. Owing to the LED having the specific light emitting angle, therefore, the light emitting from the LED may enter the fluorescent encapsulant and the package carrier at specific angles. As a result, the light emitting angle of the LED package structure is limited, not able to have a relatively larger light emitting angle.

### SUMMARY OF THE INVENTION

Accordingly, the invention is directed to a package carrier, which enlarges the range of the light emitting angle of the carried light emitting unit thereof.

A package carrier is suitable for carrying at least one light emitting unit. The package carrier includes an annular shell and a transparent light guiding stage. The annular shell has a cavity. The transparent light guiding stage is disposed in the cavity of the annular shell. The light emitting unit is adapted to be disposed on the transparent light guiding stage, and a horizontal projection area of the transparent light guiding stage is greater than that of the light emitting unit. The light emitting unit emits a light beam to enter the transparent light guiding stage and the light beam emits from a surface, relatively distant from the cavity, of the transparent light guiding stage.

In an embodiment of the invention, the material of the annular shell is a transparent material.

In an embodiment of the invention, the package carrier further includes a reflective base. The reflective base is disposed in the cavity of the annular shell, wherein the transparent light guiding stage is located on the reflective base. The light emitting unit emits the light beam to enter the transparent light guiding stage. The light beam is reflected by the reflective base, and then emitted out from the surface of the transparent light guiding stage.

In an embodiment of the invention, the package carrier further includes a heat dissipation base. The annular shell is disposed on the heat dissipation base, wherein the reflective base and the heat dissipation base are seamlessly connected therebetween.

In an embodiment of the invention, the material of the heat dissipation base includes reflective metal material.

In an embodiment of the invention, the package carrier further includes a heat dissipation base, wherein the annular shell is disposed on the heat dissipation base.

In an embodiment of the invention, the material of the heat dissipation base includes a reflective metal material.

In an embodiment of the invention, the package carrier further includes a first metal bracket and a second metal bracket. The first metal bracket is located underneath the annular shell and extends out of the annular shell. The second metal bracket is located underneath the annular shell and extends out of the annular shell, wherein the first metal bracket and the second metal bracket are disposed oppositely to each other.

In an embodiment of the invention, the at least one light emitting unit includes a light-emitting diode chip and a combination of a plurality of light-emitting diode chips with the same or different colors.

Based on the above-mentioned, owing to the package carrier of the invention having the transparent light guiding stage, and the horizontal projection area of the transparent light guiding stage is greater than the horizontal projection area of the light emitting unit. Accordingly, the light beam emitted from the light guiding unit may enlarge the range of the light emitting angle through the light guiding effects of the transparent light guiding stage. As a result, the package carrier of the invention is able to effectively expand the range of the light emitting angle of the carried light emitting unit thereof.

In order to make the features and advantages of the present invention more comprehensible, the present invention is further described in detail in the following with reference to the embodiments and the accompanying drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the invention.

FIG. 1 is a schematic perspective view of a package carrier according to an embodiment of the invention.

FIG. 2 is a schematic exploded perspective view of a package carrier according to another embodiment of the invention.

### DESCRIPTION OF THE EMBODIMENTS

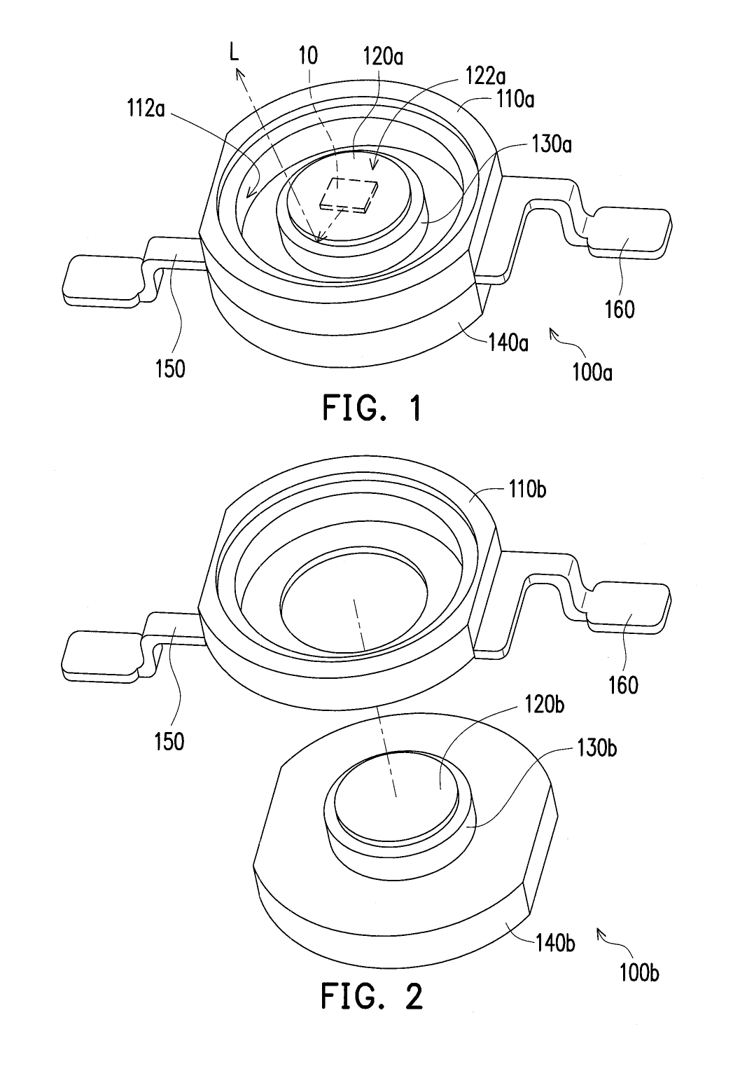

FIG. 1 is a schematic perspective view of a package carrier according to an embodiment of the invention. Referring to FIG. 1, in the present embodiment, the packaging carrier 100a is adapted to carry at least one light emitting unit 10 (only a light emitting unit 10 is schematically illustrated in FIG. 1). The package carrier 100a includes an annular shell 110a and a transparent light guiding stage 120a. The annular shell 110a has a cavity 112a. The transparent light guiding stage 120a is disposed in the cavity 112a of the annular shell 110a, wherein the light emitting unit 10 is adapted to be disposed on the transparent light guiding stage 120a, and the horizontal projection area of the transparent light guiding stage 120 is greater than that of the light emitting unit 10. The light emitting unit 10 emits a light beam L to enter the transparent light guiding stage 120a, and the light beam L emits from a surface 122a, relatively distant from the cavity 112a, of the transparent light guiding stage 120a.

To be more specific, in the present embodiment, the annular shell 100a may be a circular shape, a square annular shape, a triangle annular shape, a diamond annular shape, or an asymmetrical annular shape (only the circular shape is schematically illustrated in FIG. 1). The material the annular shell 110a is, for example, a non-transparent material or a transparent material, preferably, a transparent material such as the plastic, but not limited herein. The transparent light guiding stage 120a has the light guiding effect, and the material thereof is, for example, the sapphire or glass substrate. In the present embodiment, the light emitting unit 10 is adapted to be disposed on the transparent light guiding stage 120a, and the horizontal projection area of the transparent light guiding stage 120a is greater than that of the light emitting unit 10. Accordingly, after the light beam L emitting from the light emitting unit 10 entering into the transparent light guiding stage 120a, the range of the light emitting angle of the light emitting unit 10 can be effectively expanded through the light guiding effects of the transparent light guiding stage 120a. Here, the light emitting unit 10 is, for instance, a LED chip. Certainly, in another embodiments not illustrated herein, the light emitting unit can be also composed of a combination of a plurality of the light-emitting diode chips with the same or different colors.

Moreover, the package carrier 100a may further include a reflective base 130a. The reflective base 130a is disposed in the cavity 112a of the annular shell 110a, and the transparent light guiding stage 120a is located on the reflective base 130a. Particularly, the light emitting unit 10 emits the light beam L to enter the transparent light guiding stage 120a. In addition, the light beam L is reflected by the reflective base 130a and emits out of the surface 122a of the transparent light guiding stage 120a through the light guiding effect of the transparent light guiding stage 120a. As a result, the design of the package carrier 100a of the present embodiment can make the light emitting unit 10 have a broader light emitting angle and the brightness of the light emitting unit may be enhanced.

Furthermore, in order to make the light emitting unit 10 carried by the package carrier 100a achieve a better heat dissipation effect, the package carrier 100a may further include a dissipation base 140a. The annular shell 110a is disposed on the heat dissipation base 140a, and the material of the heat dissipation base 140a is, for example, a reflective metal material. In another embodiment, referring to FIG. 2, the transparent light guiding stage 120b of the package carrier 100b is disposed on the reflective base 130b, and the annular shell 110b is disposed on the heat dissipation base 140b. The reflective base 130b and the heat dissipation base 140b may be seamlessly connected therebetween. That is, the reflective base 130b and the heat dissipation base 140b are the integrally formed structure, and this is still a technical aspect of the present invention may be employed, without departing from the scope of the present invention.

On the other hand, the package carrier 100a of the present embodiment further includes a first metal bracket 150 and a second metal bracket 160. The first metal bracket 150 is located underneath the annular shell 110a and extends out of the annular shell 110a. The second metal bracket 160 is located underneath the annular shell 110a and extends out of the annular shell 110a, wherein the first metal bracket 150 and the second metal bracket 160 are disposed oppositely to each other, and adapted to electrically connect with an external circuit (not illustrated). That is, the light emitting unit 10 on the package carrier 100a of the present embodiment can be electrically connected with an external circuit through the first metal bracket 150 and the second metal bracket 160, so as to extend the scope of the application areas.

Because the package carrier 100a of the present embodiment has the transparent light guiding stage 120a, and the horizontal projection area of the transparent light guiding stage 120a is greater than that of the light emitting unit 10. Thus, the light beam L emitting from the light emitting unit 10 can expand the range of the light emitting angle thereof through the light guiding effect of the transparent light guiding stage 120a. Moreover, transparent light guiding stage 120a may be disposed on the reflective base 130, and thereby the light beam L emitting from the light emitting unit 10 may enter the transparent light guiding stage 120a. Otherwise, the light beam L may be reflected by the reflective base 130a, and emitted out from the surface 122a of the transparent light emitting stage 120a. As a result, the package carrier 100a of the present embodiment can effectively expand the range of the light emitting angle and increase the brightness of the light emitting unit. Moreover, the package carrier 100a of the present embodiment may enhance the heat dissipation effect of the light emitting unit 10 through the configuration of the heat dissipation base 140a.

In summery, the package carrier of the invention has a transparent light guiding stage, and the horizontal projection area of the transparent light guiding stage is greater than that of the horizontal projection area of the light emitting unit. Therefore, the light beam emitting from the light emitting unit can expand the range of the light emitting angle through the light guiding effect of the transparent light guiding stage. As a result, the package carrier of the present invention can effectively expand the range of the light emitting angle of the carried light emitting unit thereof.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A package carrier suitable for carrying at least one light emitting unit, the package carrier comprising:
an annular shell having a cavity; and
a transparent light guiding stage disposed in the cavity of the annular shell, wherein the light emitting unit is adapted to be disposed on the transparent light guiding stage, and a horizontal projection area of the transparent light guiding stage is greater than a horizontal projection area of the light emitting unit, the light emitting unit emits a light beam to enter the transparent light guiding stage, and the light beam emits from a surface of the transparent light guiding stage relatively distant from the cavity.

2. The package carrier as claimed in claim 1, wherein the material of the annular shell is a transparent material.

3. The package carrier as claimed in claim 1, further comprising a reflective base disposed in the cavity of the annular shell, wherein the transparent light guiding stage is located on the reflective base, the light emitting unit emits the light beam to enter the transparent light guiding stage, and the light beam is reflected from the reflective base and emits out from the surface of the transparent light guiding stage.

4. The package carrier as claimed in claim 3, further comprising a heat dissipation base, the annular shell disposed on the heat dissipation base, wherein the reflective base and the heat dissipation base are seamlessly connected therebetween.

5. The package carrier as claimed in claim 4, wherein the material of the heat dissipation base comprises a reflective metal material.

6. The package carrier as claimed in claim 1, further comprising a heat dissipation base, the annular shell disposed on the heat dissipation base.

7. The package carrier as claimed in claim 6, wherein the material of the heat dissipation base comprises a reflective metal material.

8. The package carrier as claimed in claim 1, further comprising a first metal bracket located underneath the annular shell and extending out of the annular shell and a second metal bracket located underneath the annular shell and extending out of the annular shell, wherein the first metal bracket and the second metal bracket are disposed oppositely to each other.

9. The package carrier as claimed in claim 1, wherein the at least one light emitting unit comprises a light-emitting diode chip and a combination of a plurality of the light-emitting diode chips with the same or different colors.
